(19) United States
(12) Patent Application Publication
(10) Pub. No.: US 2009/0007143 A1
(43) Pub. Date: Jan. 1, 2009

(54) SERVER QUOTA NOTIFICATION

(75) Inventors: Li-Kai K. Chang, Redmond, WA (US); Michael Clyde Medlock, Seattle, WA (US); Hsuan-Yu Jerry Lin, Seattle, WA (US); William S. Stauber, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/769,824

(22) Filed: Jun. 28, 2007

(51) Int. Cl. G06F 3/00

(52) U.S. Cl. 719/318

(57) ABSTRACT

A system that enables notification of a critical quota status related to a mail (or Exchange) server is provided. The system can employ parameters directly from a mail server or, alternatively, from a stats store located within a client device to trigger generation and delivery of a quota full (or exceeded) state. This alert can be locally generated within the client device to convey the critical quota status. In operation, the alert protocol can employ most any protocol including but, not limited to, an email, calendar entry, task, instant message (IM), or the like. In the case of an email alert, the system can timestamp the alert thereby making it always appear on the top of the inbox thus, conspicuous to a user.

### BACKGROUND

With the ever-increasing popularity of personal mobile devices, e.g., cell phones, smartphones, personal digital assistants (PDAs), personal music players, laptops, etc., ‘mobility’ has been the focus of many consumer products as well as services offered by wireless providers. In the telecommunications industry, ‘mobility’ is at the forefront as consumers are no longer restricted by location with regard to communications and computing needs. Rather, today, as technology advances, more and more consumers use portable devices in day-to-day communications, activities, planning and entertainment.

As mobile device popularity increases, the ability to make telephone calls, access electronic mail, communicate via instant message (IM) and access aggregated online services such as a calendar appointments and tasks from any location has also continued to evolve. Many mobile devices such as cell phones, smartphones, PDAs or the like enable wireless synchronization with servers, for example mail servers. Accordingly, electronic messages can be sent and/or received via mobile devices by way of wireless synchronization.

Although wireless technology for data transmission and synchronization has been available for quite some time, status notification limitations plague users. More particularly, today, mobile device notification limitations with respect to electronic mail deliver is limited. For example, when sending a message, if server quota is exceeded or another error occurs during transmission, mechanisms do not exist to effectively alert the user of problems with transmitting the electronic mail.

Oftentimes, when wirelessly synchronizing to a mail server via a mobile device, a user may assume that a message is delivered if an error is not effectively conveyed. However, many times the message is not sent due to the fact that server quota may be exceeded. Thus, the server will prohibit sending and/or receiving electronic mail until the storage quota is adjusted within an allotted amount of storage.

Many enterprises limit their users to a maximum mailbox quota on the network. If a mobile user exceeds this quota, he/she is unable to send email from the mobile device. In conventional mobile applications, the user does not get immediate feedback that their email did not get sent because of the quota full condition. Rather, this error is most often embedded within a synchronization application, if at all. Because notification is not conveyed to users, most users will not even notice the email has not been sent until later, which can cause delay in critical communications. In other words, identifying a critical level (or quota full) condition so that the user knows they need to take action is not effectively conveyed in accordance with traditional systems.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that enables notification of a critical quota status related to an electronic mail (or Exchange) server. In a particular aspect, the system can employ parameters from a stats store within a client device to trigger generation and delivery of a quota full (or exceeded) state. In disparate aspects, the alert protocol can be most any protocol including but, not limited to, an email, calendar entry, task, instant message (IM), or the like. Similarly, a communication protocol can be personalized to enhance effectiveness of the alert.

Accordingly, the innovation can clearly inform a user when they have exceeded their mail or Exchange server quota. Essentially, the innovation finds a good balance between informing the user within the right context of the system, without being too obtrusive across the system. In one aspect, balance is achieved by placing a ‘simulated’ or mock email message in the mobile device inbox of the correct account. This ‘simulated’ email can appear as if it was sent from an email administrator when, in fact, it is locally generated within the mobile device to alert the user of a quota full status.

To the system, the simulated email (or other alert) seems like a normal message, and the user is notified in the normal way. Accordingly, this message is time-stamped with the date and time of the synchronization when the error (e.g., quota full) was detected. Thus, the simulated email should always be at the top of the email list, for example, if the inbox is sorted by date received in descending order.

In other aspects, the alert can advise the user how to clear an alert condition. For example, specific instructions can be conveyed within the alert that advises a user how to free space therefore alleviating the quota full status. When a synchronization operation is successful, this alert message can be removed and, if desired, logged for later analysis.

In still other aspects, a status entry can be added to the ‘state and notification broker’ or stats store that allows any application to detect and employ the alert condition. As such, third party applications can display personalized alerts (e.g., a home page plug-in) as desired. Moreover, developers can generate plug-ins that can be employed by users to more effectively convey alert situations. This extension of the stats store entry allows third party developers to innovate on top of the platform.

With many users, exceeding server quota is a common event, as their quota is often set very low by an enterprise. Additionally, the user may be engaged in other tasks on their device (e.g., calling on the phone, browsing the Internet) and may not want to be bothered with an obtrusive pop-up dialog alert. The innovation's user experience finds an elegant balance between alerting the user, while not being too obtrusive (e.g., a system modal pop-up dialog). It can also alert the user within the right (or desired) context (since the mobile device may be connected to more than one e-mail server). Further, the innovation can leverage the existing mechanisms for new e-mail notifications.

In yet another aspect thereof, an artificial intelligence component is provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a system that facilitates notification of mail server critical status alerts in accordance with an aspect of the innovation.

FIG. 2 illustrates an example flow chart of procedures that facilitate generation and delivery of alerts in accordance with an aspect of the innovation.

FIG. 3 illustrates an example flow chart of procedures that facilitate selection and update of an alert in accordance with an aspect of the innovation.

FIG. 4 illustrates an example block diagram of a notification management component that facilitates generation and rendering of an alert in accordance with an aspect of the innovation.

FIG. 5 illustrates an example block diagram of an alert generation component that facilitates alert selection in accordance with an aspect of the innovation.

FIG. 6 illustrates an example block diagram of a rendering component that facilitates conspicuous delivery of the alert to a user in accordance with an aspect of the innovation.

FIG. 7 illustrates an architecture including a machine learning and reasoning-based component that can automate functionality in accordance with an aspect of the innovation.

FIG. 8 illustrates a block diagram of a mobile device capable of alerting a user of a critical status (e.g., quota full) in accordance with an aspect of the innovation.

FIG. 9 illustrates a block diagram of a computer operable to execute the disclosed architecture.

FIG. 10 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

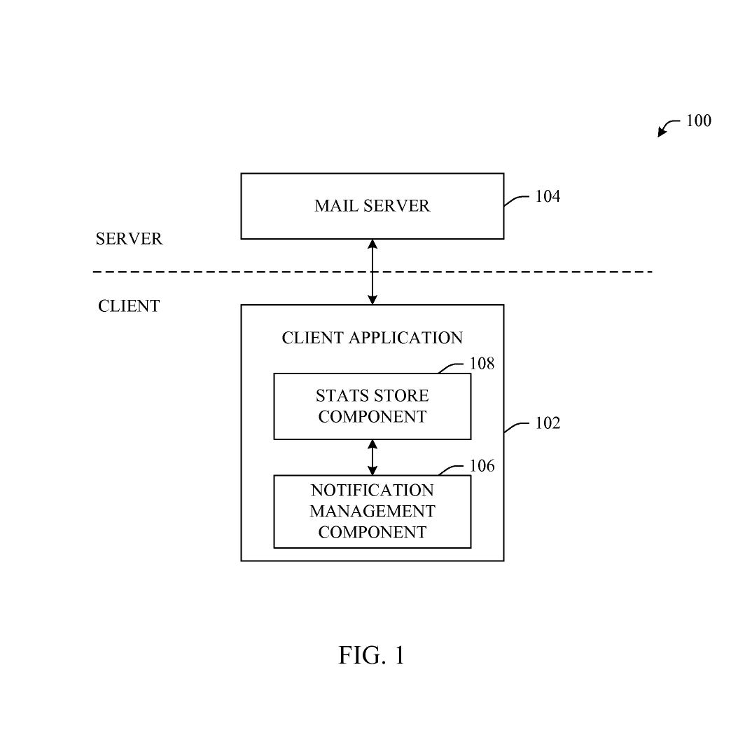

Referring initially to the drawings, FIG. 1 illustrates a system 100 that enables efficient detection of an inability to transfer data, and particularly messages, due to a critical server quota. For example, the system 100 can alert a user when a mail server quota is full, thereby affording the opportunity to free space. Thus, once the space is freed, the quota full status will be alleviated and the user will be able to function normally by sending data and messages without issue.

As described above, many enterprises limit their users to a maximum mailbox folder size quota on the network. This quota can be based on most any factor including, but not limited to, job function, classification, scope or the like. No matter the reason for the quota, it is important that the user (e.g., employee) is aware of the status as the quota is approached and ultimately reached. Here, the features, functions and benefits of the innovation disclose mechanisms by which these conditions can be effectively conveyed to a user. In operation, an alert can be locally generated by way of the mobile device applications thus, prompting a user to take action when a quota issue is discovered.

As will be understood, if a mobile user exceeds an enterprise-defined folder size quota, he/she will be unable to send e-mail from the mobile device. Today, there is no effective or conspicuous mechanism for the average user to get immediate feedback that an email did not get sent because of the quota full condition. Conventionally, a user is forced to search within applications (e.g., synchronization application, email application) for evidence that a communication (e.g., email, instant message (IM), text message) was (or was not) sent. In one example, a user will have to check their ‘Outbox’ and/or corresponding ‘Sent’ box to verify that an email was actually sent to a recipient.

While most users lack the technical expertise to look for, and sometimes decipher non-transmittal evidence, this is a very time intensive task that can lead to error. Because of the difficulty in deciphering traditional signs of non-transmittal, most users will not notice the email has not been sent until later, sometimes when it's too late. This can cause delay in critical communications and therefore can be expensive leading to many other issues. When a quota full issue is discovered, a user can take action such as emptying ‘Deleted Items’ to alleviate the problem by freeing server space via the device. However, identifying this condition so the user knows they need to take action is not as straightforward as it should be with regard to traditional systems.

Referring again to FIG. 1, the system 100 generally includes a client application 102 and a server component 104, shown as a ‘mail server’ in FIG. 1. While many of the examples described herein are directed to monitoring status and/or delivery of email via an email server, it is to be understood that this system 100 is to apply to most any server capable of synchronizing and/or sending information on behalf of a client. For example, other modalities such as, IM, text messaging, or like applications are to be included within the scope of this specification and claims appended hereto.

As illustrated, the client application component 102 can include a notification management component 106 that facilitates generation and communication of an alert related to server quota status. In one specific example, the notification management component 102 can locally generate an email which conveys server quota status. In operation, the notification management component 106 can generate this email and place it on the top of an ‘inbox’ stack such that a user can notice it as an unread message. It is to be understood that this email can be generated locally by the client application 102. Thus, the mail server 104 is not obligated to generate and/or send the message.

Here, the mail server 104 can supply server quota parameters by way of the stats or status store component 108. The stats store component 108 can provide a mechanism for storing system and application information in the registry. Thus, this information can provide a notification system for changes in the stored information. Therefore, components such as the notification management component 106 can be made aware of events and server status. In this example, the parameters or information can establish quota status thereby enabling notification to the user of most any quota status issues, for example, ‘quota full’ status.

It will be understood that the notification management component 106 can prompt action to rectify a quota issue. In embodiments, the action can be manually triggered by a user or automatically on behalf of a user. For example, rules-based and/or machine learning and reasoning (MLR) mechanisms can be employed to automate actions in accordance with quota status issues.

In one aspect, in operation, when the client application 102 performs a synchronization action to the mail server 104, if the mail server 104 returns a quota exceeded synchronization error, the notification management component 106 can locally establish a device-generated administrative message and insert the message into the ‘inbox’ of the user account. The below table illustrates an example list of parameters which can be included with the notification.

| | |
|---|---|
| From | Administrator |
| To | <User name> |
| Subject | Your mailbox is full |
| Date | Date/Time of sync error |
| Sent and | |
| Received | |
| Message | Your Exchange server mailbox is full. You will not be |
| | able to send or receive any e-mail while your mailbox |
| | is full. To restore service, you should delete some |
| | unnecessary e-mails, and then press Menu → Tools → |
| | Empty Deleted Items to create space on your server. |

It is to be understood that the synchronization can be prompted or triggered in most any manner. For example, the synchronization action can be triggered by selecting ‘Menu’ and then ‘Send/Receive’ on a device. Similarly, sending an email can prompt synchronization if the default schedule is set to ‘send/receive emails upon clicking send.’ Other options that can automatically trigger synchronization are ‘Always Up-To-Date Synchronization’ and predefined scheduled synchronization.

Regardless of the method of triggering the synchronization, it is to be understood that this quota full message will be refreshed (e.g., Date/Time updated) every time the error occurs. Additionally, if the user deletes the message, then it is re-created if the status persists. Still further, if, upon a subsequent synchronization action, the error is not returned, then the message can be automatically removed (and logged if desired).

As described above, the mail server quota exceeded status can be included in the client ‘state and notification broker’ or stats store component 108. The registry key that denotes this status can be as follows:

```
    Root Key: SN_EXCHANGEQUOTAEXCEEDED_ROOT
    HKEY_CURRENT_USER
    Path: SN_EXCHANGEQUOTAEXCEEDED_PATH
    TEXT(“Software\\ABC\\Shell”)
    Key name: SN_EXCHANGEQUOTAEXCEEDED_VALUE
    BOOLEAN(“QuotaExceeded”)
Where QuotaExceeded =
    ‘True’ means that, as of the last synchronization action, the user's
    mail quota was exceeded.
    ‘False’ means that, as of the last synchronization action, the user's
    mail quota was not exceeded.
    Null means the synchronization application has not set this value.
```

It will be understood that the synchronization application updates this value on every synchronization action. As such, this value can be made available for most any other application (e.g., home screen plug-in) to query and display an indicator for the user. Clicking the indicator can pop-up an alert with text the third party application can customize. The ability to employ a plug-in is described in accordance with the figures that follow infra.

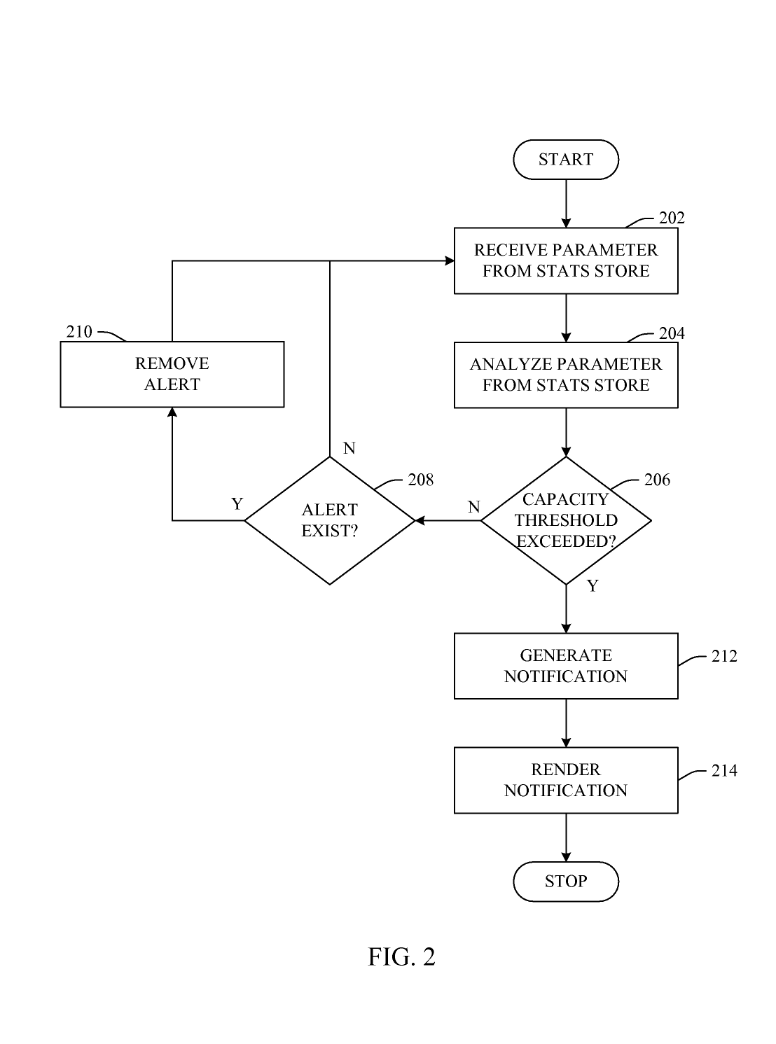

FIG. 2 illustrates a methodology of notifying of a server quota full status in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, a parameter is received, accessed or otherwise obtained from the stats store. Continuing with the aforementioned example, the parameter can be a quota status level with regard to a mail server. As described supra, enterprises often allocate a specified amount of space to a user for which to employ on a mail server. In aspects, this space can apply to email, calendar appointments, tasks, etc. or any combination thereof. Accordingly a stats store can be updated with regard to the amount of storage used.

At 204, the parameter(s) obtained from the stats store (or from the mail server) can be analyzed. Thus, a determination can be made at 206 to establish if a defined capacity threshold has been exceeded. Although many of the aspects described herein employ a stats store to communicate quote full status or flags, it is to be appreciated that this information can be obtained ‘on-the-fly’ in real-time (or near real-time) from the mail server in alternative aspects. These alternative aspects are to be included within the scope of the innovation and claims appended hereto.

If, however, at 206, the capacity is not reached, at 208, a second determination can establish if an alert already exists. If an alert does exist, the alert can be removed at 210 and the flow can return to 202 to receive additional parameters. However, if an alert does not exist, the flow can return to 202, again, to receive additional parameters.

If the capacity threshold is exceeded at 206 a notification or alert can be generated at 212 and rendered at 214. It will be understood that this alert can be generated locally (e.g., within the mobile device) and rendered in a manner that will be conspicuous to a user. For instance, in the case of an email capacity full alert, a mock email can be established as described supra and subsequently injected into a user's ‘inbox’. Here, this alert can be rendered into a user's inbox in normal fashion or alternative personalized with additional effects.

For instance, a third party plug-in can be crafted and used to personalize delivery and/or notification of the alert. It is to be understood that the details of such a plug-in can vary in alternative embodiments. However, the features, functions and benefits of such a plug-in can encompass those described herein. Thus, third party plug-ins that incorporate the features, functions and benefits of the innovation are to be included within the scope of this innovation and claims appended hereto.

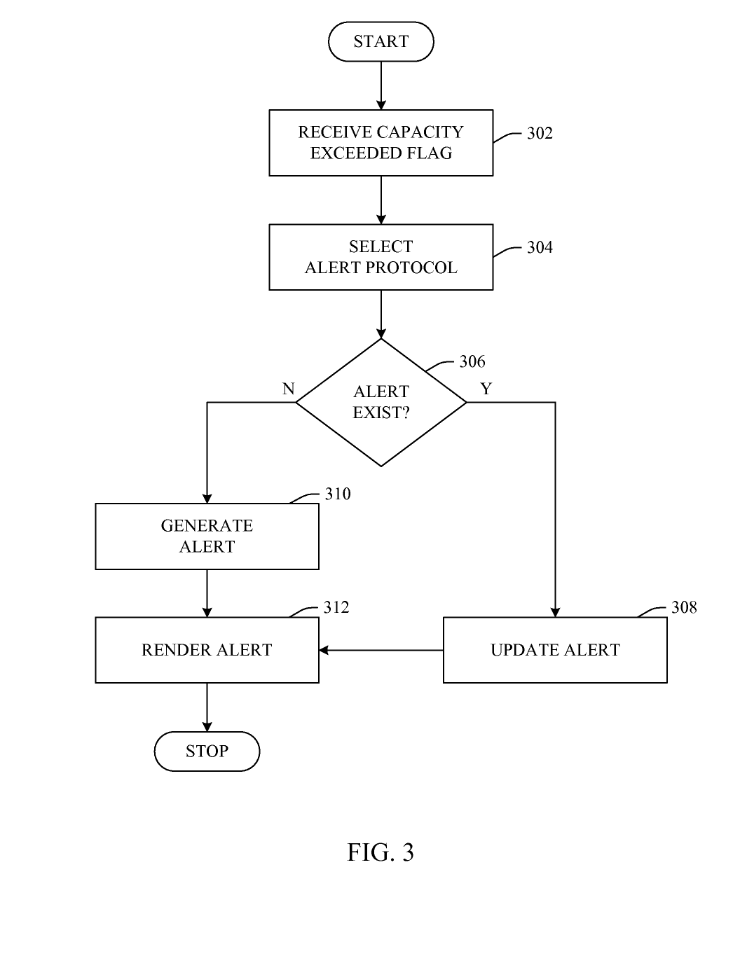

Referring now to FIG. 3, there is illustrated an alternative methodology of rendering a server quota alert in accordance with the innovation. At 302, a capacity exceeded flag can be received. For example, this flag (or parameter) can be received directly from a mail server or alternatively injected into a stats store and obtained therefrom.

At 304, an alert protocol can be selected. For example, the alert that conveys a capacity exceeded status can be conveyed in most any manner, including but not limited to, email, IM, text message, audible notification, visual notification, third party plug-in or the like. As described above, a third party plug-in can be employed to personalize an alert and method of rendering such alert. It is to be understood that, in the aspects, the alert is formulated on the client side of the system utilizing information gathered from the server side of the system.

As mentioned above, the alert can take most any form desired by a user. A determination is made at 308 to establish if an alert already exists for the capacity exceeded issue. If at 308 it is determined that an alert exists, the alert can be updated to include accurate information such as, but not limited to, timestamp information, undeliverable email counts, recipient information, subject information or the like.

Alternatively, if it is determined at 306 that the alert does not exist, an alert can be generated at 306. Here, the alert is generated in accordance with the selected protocol from 304. In either case, the alert is rendered at 312. As described supra, the rendering protocol can include an email application, IM application, text message, plug-in or the like.

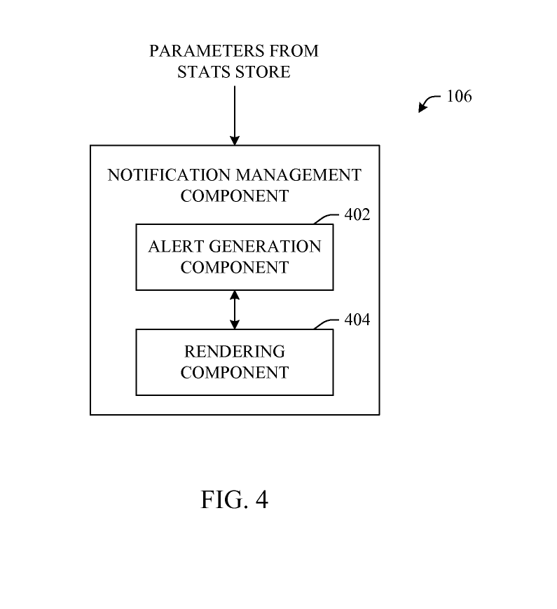

FIG. 4 illustrates an example block diagram of a notification management component 106 in accordance with the innovation. As shown, the notification management component 106 can include an alert generation component 402 and a rendering component 404 that together facilitate conveying a capacity exceeded alert to a user. Each of these components and corresponding functionality will be described infra.

The alert generation component 402 can facilitate monitoring the parameters from the stats store (108 of FIG. 1) whereas when appropriate (e.g., when quota is full) an alert can be selected and generated. Continuing with the email example above, when mail server capacity is reached or exceeded, the alert generation component can inject a mock email into a user's inbox which identifies the quote full status. Additionally, the alert can instruct the user how to alleviate the issue of the quota full status.

The rendering component 404 can communicate the alert to the user. As described above, the rendering component 404 can inject the alert into the user inbox thereby making the alert conspicuous such that it will be noticed. In doing so, the rendering component 404 evaluates the type of alert and employs logic to select an efficient or even optimal protocol by which to convey to the user. It is to be understood that both the alert generation component 402 and the rendering component 404 can employ rules-based or MLR-based logic to determine or infer a preference of a user. Thus, the protocols for the type of alert as well as the mode of delivery can be automatically selected on behalf of the user.

As described above, the alert can give suggestions for alleviation of the quota full status. In one example, the alert can suggest a user to ‘empty deleted items’ or EDI. EDI is a feature that allows a user to remotely clear their ‘Deleted Items’ folder on their mail server from a suitably connected mobile device. Unlike a standard ‘delete’ which places items into the Deleted Items folder but still consumes the same amount of memory space, this EDI action actually frees up quota space on a server. Accordingly, the quota full status can be relieved and mail can again be sent and/or received via the mobile device. It will be appreciated that many of the client-server connections are initiated outside the context of a full Sync (e.g., ‘out-of-band’). Moreover, many current mobile device folder operations are performed in this manner between a client and a server.

As described supra, the alert generation component 402 enables alerting users of important server conditions (e.g., server quota full status) that are blocking their actions (e.g., prohibiting email send), without being intrusive or giving the impression that the device or service is unstable. Further, the alert generation component 402 extends the platform in a way that others (original equipment manufacturers (OEMs), third parties) can develop other creative ways of alerting the user. These other creative ways can be incorporated into a plug-in and employed by a user to personalize notification mechanisms.

An alert can be presented when a user initiates certain actions that result in a manual synchronization with a mail server, and an error is returned because the account quota is full. Additionally, the innovation can automatically check a synchronization application detailed error message store to determine if a mail server account quota full condition is present. Still further, in other aspects, the innovation includes the ability to programmatically query the mail server quota status in the device's stats store.

The following scenarios are included to add perspective to the innovation and are not intended to limit the innovation in any way. Accordingly, it is to be understood that other aspects exist and are to be included within the scope of the innovation and claims appended hereto. These example scenarios describe situations where the features, functions and benefits of the innovation will be particularly useful in notifying a user of a quota full status.

In a first ‘critical’ example scenario, Sue's Exchange Server account has exceeded the maximum quota size on the server. Sue has to set up an important meeting, composes, and sends the meeting notice. Sue sees a notification that her email for the meeting notice could not be sent (in her user-triggered sync) because her server quota is full. Sue immediately uses the EDI feature to free enough space to send the meeting notice or returns to her personal computer if additional cleanup is required. It is apparent that Sue is a savvy synchronization user astute enough to check the synchronization application to determine if the communication was sent.

In a second ‘desired’ example scenario, Gary's mailbox exceeds maximum quota size on the server. Gary has to setup an important meeting, composes, and sends the meeting notice. Gary happens to know that his mobile devices operating system does not notify him when emails are not sent due to the server quota being full since he had previous bad experiences with missed emails/meeting notices. Gary checks the folder list, sees that the meeting notice is stuck in his outbox, and is glad that he remembered to double check the operation. Gary checks in the synchronization application and sees the attention required notice with detail message that tells him that his exchange server quota is full and some emails could not be sent. Gary immediately uses the EDI feature to free enough space to send the meeting notice or returns to his personal computer if additional cleanup is required. Here, like Sue, Gary is also astute enough to check the outbox and the synchronization application to confirm that the communication was sent.

In yet a third ‘desired’ scenario, Jim wants to be better informed as to the status of his Exchange server quota. As he is a mobile application developer, he writes a home screen plug-in for email. When the mail server quota is full, Jim's plug-in shows an exclamation point to indicate that some action has to be taken. Jim's plug-in knows the status of his mail server quota by querying the stats store. In each of these scenarios, it is to be appreciated that the subject innovation can automatically detect and address the quota issues on behalf of the user.

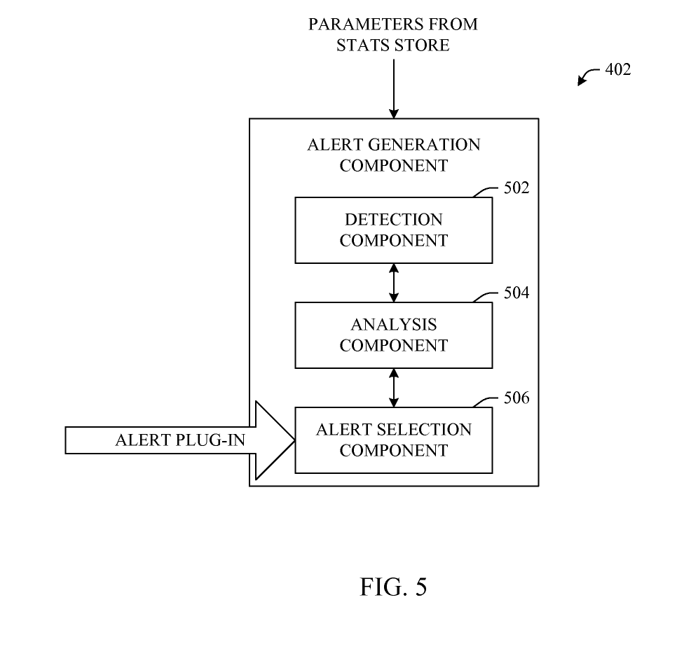

Turning now to FIG. 5, an example block diagram of an alert generation component 402 is shown. As illustrated, the alert generation component 402 can include a detection component 502, an analysis component 504 and an alert selection component 506. In operation, these sub-components enable an alert to be generated in order to convey a critical status (e.g., server quota full) to a user.

The detection component 502 can monitor the quota of a mail server. In one example, the detection component 502 can monitor the stats store in order to identify a quota full condition. Additionally, the detection component 502 can communicate with a mail server to directly determine quota status.

The analysis component 504 can employ logic to evaluate the quota status. If it is determined by the analysis component 504 that a quota full condition should be addressed, the alert selection component 506 is employed to establish what type of alert protocol should be employed to notify a user of the quota full status. By way of example, an email can be employed to alert a user. In this example, the alert generation component 402 can establish an email to convey the quota full status. Alternatively, as shown, an alert plug-in can be employed by the alert selection component 506 in order to establish a desired (and effective) alert protocol.

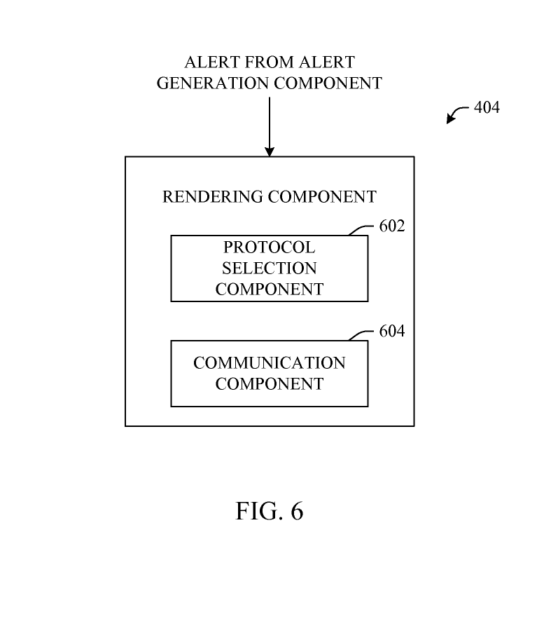

FIG. 6 illustrates an example block diagram of a rendering component 404 in accordance with an aspect of the innovation. As shown, the rendering component 404 can include a protocol selection component 602 and a communication component 604 which facilitate determination of delivery protocol and employment of the delivery protocol respectively to render the alert.

In operation, the protocol selection component 602 can select an appropriate means by which to deliver the alert. For example, the protocol selection component 602 can select an appropriate plug-in or other application to employ in rendering the alert. The communication component 604 can be employed to inject the alert into the selected protocol.

While a user's mail server contains emails, calendar appointments, contacts, tasks, and notes, users often associate quota management with email management. As such, when users manage their mail quota, they sometimes only delete emails, rather than calendar appointments, contacts, or tasks, which also free memory. In accordance with the innovation, the alert can include information that advises a user alternative manners by which to free space, thereby alleviating a quota full scenario.

Additionally, in aspects, the innovation can employ a non-intrusive, system-wide alert system called a ‘bubble.’ This mechanism allows an application to signal to the user that a warning condition (such as a quota full) exists that may require their attention. By clicking the bubble, the innovation can reveal additional information of how to alleviate the situation. The alert can be constrained to the context of the messaging application, for the account that is over quota. As well, it is to be understood that most any mechanism can be employed by the rendering application 404 to convey the alert and information contained therein.

Continuing with the ‘bubble’ alert example above, any time the mail server returns a synchronization quota exceeded error, a ‘bubble’ alert can contain the following message:
“Your server mailbox is full. You will not be able to send or receive any e-mail. To restore service, you should delete some unnecessary e-mails, and then press Menu→Tools→Empty Deleted Items to create space on your server.”

On both of the example platforms, if the mobile device performs a synchronization operation and the mail server returns a quota exceeded synchronization error, then a device-generated (e.g., locally generated) administrative message can be created and inserted into the inbox of that account. The parameters of the e-mail can be as illustrated in the following table:

| | |
|---|---|
| From | Administrator |
| To | <User name> (Note: Can we get this?) |
| Subject | Your mailbox is full |
| Date Sent | Date/Time of sync error |
| and | |
| Received | |
| Message | Your Exchange server mailbox is full. You will not be |
| | able to send or receive any e-mail while your mailbox |
| | is full. To restore service, you should delete some |
| | unnecessary e-mails, and then press Menu → Tools → |
| | Empty Deleted Items to create space on your server. |

As described above, it is to be understood that the synchronization operation can be trigged manually by selecting Menu→Send/Receive, by sending an e-mail, if the synchronization schedule option for “Send/receive when I click Send” is selected (e.g., default), if the Always-Up-To-Date synchronization is selected or if a scheduled synchronization is desired.

Moreover, it will be understood that the alert message can be refreshed (e.g., the Date/Time updated) every time the error occurs. Similarly, if the user deletes the message, then it can be re-created. Still further, if, on the next synchronization operation, the error is not returned, then the message is removed.

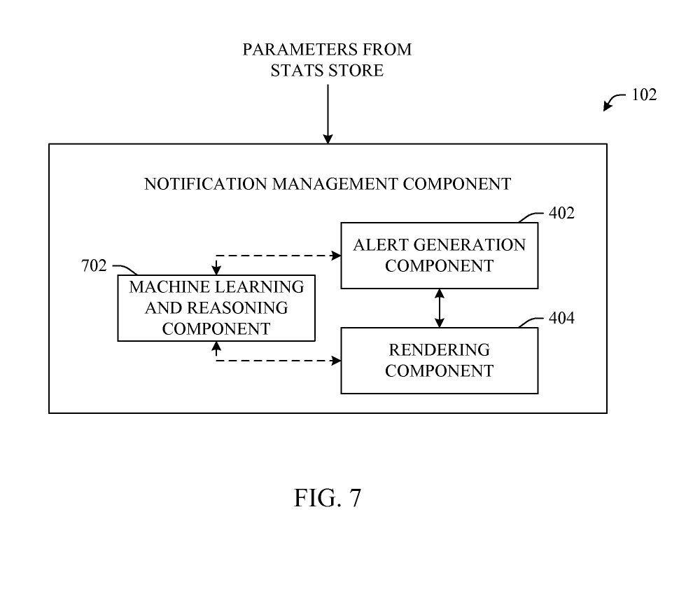

FIG. 7 illustrates a system 700 that employs an artificial intelligence (AI) or MLR component 702 which facilitates automating one or more features in accordance with the subject innovation. The subject innovation (e.g., in connection with alert or communication protocol selection) can employ various AI-based schemes for carrying out various aspects thereof. For example, a process for determining which type of alert to generate, what information to include within the alert, or how to convey the alert can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to alert a user, how to generate an alert a user, optimal manner by which to convey the alert to a user, or the like.

It is to be understood and appreciated that the MLR can include contextual awareness whereby inferences can be made in accordance with a current context of a user. By way of example, the MLR logic (or rules-based logic) can employ location, current activity, time/date, audience of the user, as well as other contextual factors to infer alert and delivery protocol. These alternative aspects are to be included within the scope of the innovation and claims appended hereto.

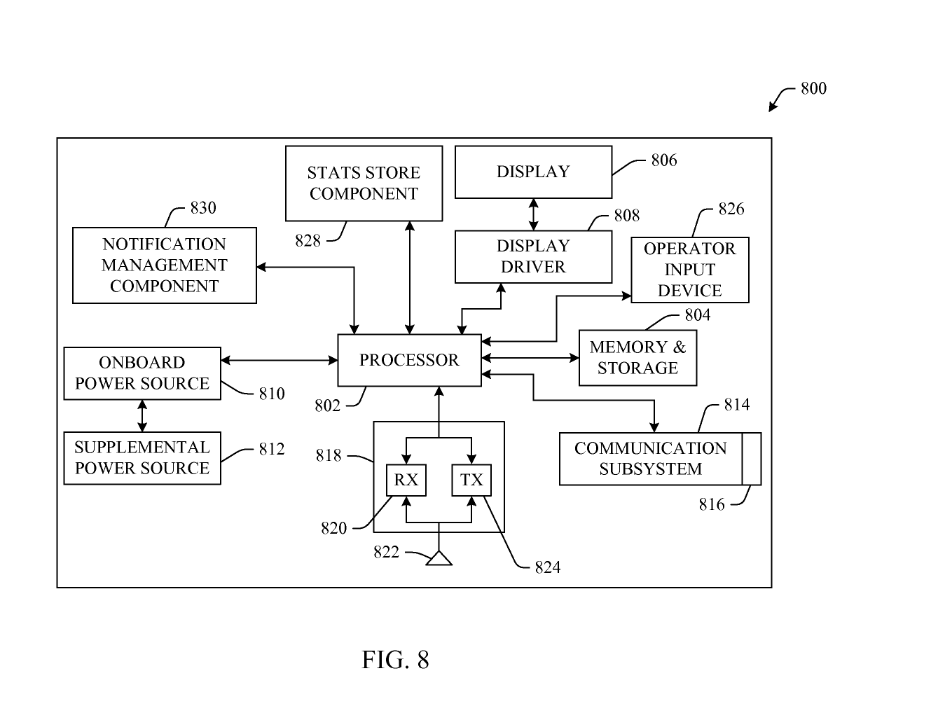

Referring now to FIG. 8, there is illustrated a schematic block diagram of a portable device 800 according to one aspect of the subject innovation, in which a processor 802 is responsible for controlling the general operation of the device 800. It is to be understood that the portable device 800 can be representative of most any portable device including, but not limited to, a cell phone, smartphone, PDA, a personal music player, image capture device (e.g., camera), personal game station, health monitoring device, event recorder component, etc.

The processor 802 can be programmed to control and operate the various components within the device 800 in order to carry out the various functions described herein. The processor 802 can be any of a plurality of suitable processors. The manner in which the processor 802 can be programmed to carry out the functions relating to the subject innovation will be readily apparent to those having ordinary skill in the art based on the description provided herein. As will be described in greater detail infra, an MLR component and/or a rules-based logic component can be used to effect an automatic action of processor 802.

A memory and storage component 804 connected to the processor 802 serves to store program code executed by the processor 802, and also serves as a storage means for storing information such as data, services, metadata, device states or the like. In aspects, this memory and storage component 804 can be employed in conjunction with other memory mechanisms that house health-related data. As well, in other aspects, the memory and storage component 804 can be a stand-alone storage device or otherwise synchronized with a cloud or disparate network based storage means, thereby established a local on-board storage of health-related data.

The memory 804 can be a non-volatile memory suitably adapted to store at least a complete set of the information that is acquired. Thus, the memory 804 can include a RAM or flash memory for high-speed access by the processor 802 and/or a mass storage memory, e.g., a micro drive capable of storing gigabytes of data that comprises text, images, audio, and video content. To this end, it is to be appreciated that the health-related data described herein can be of most any form including text (e.g., sensor readings), images (e.g., captured image sequences) as well as audio or video content. According to one aspect, the memory 804 has sufficient storage capacity to store multiple sets of information relating to disparate services, and the processor 802 could include a program for alternating or cycling between various sets of information corresponding to disparate services.

A display 806 can be coupled to the processor 802 via a display driver system 808. The display 806 can be a color liquid crystal display (LCD), plasma display, touch screen display or the like. In one example, the display 806 is a touch screen display. The display 806 functions to present data, graphics, or other information content. Additionally, the display 806 can display a variety of functions that control the execution of the device 800. For example, in a touch screen example, the display 806 can display touch selection buttons which can facilitate a user to interface more easily with the functionalities of the device 800.

Power can be provided to the processor 802 and other components forming the device 800 by an onboard power system 810 (e.g., a battery pack). In the event that the power system 810 fails or becomes disconnected from the device 800, a supplemental power source 812 can be employed to provide power to the processor 802 (and other components (e.g., sensors, image capture device)) and to charge the onboard power system 810. The processor 802 of the device 800 can induce a sleep mode to reduce the current draw upon detection of an anticipated power failure.

The device 800 includes a communication subsystem 814 having a data communication port 816, which is employed to interface the processor 802 with a remote computer, server, service, or the like. The port 816 can include at least one of Universal Serial Bus (USB) and IEEE 1394 serial communications capabilities. Other technologies can also be included, but are not limited to, for example, infrared communication utilizing an infrared data port, Bluetooth™, etc.

The device 800 can also include a radio frequency (RF) transceiver section 818 in operative communication with the processor 802. The RF section 818 includes an RF receiver 820, which receives RF signals from a remote device via an antenna 822 and can demodulate the signal to obtain digital information modulated therein. The RF section 818 also includes an RF transmitter 824 for transmitting information (e.g., data, service) to a remote device, for example, in response to manual user input via a user input 826 (e.g., a keypad) or automatically in response to a detection of entering and/or anticipation of leaving a communication range or other predetermined and programmed criteria.

A stats store component 828 is provided which, as described supra, can facilitate storage of parameters related to the mail server (e.g., 104 of FIG. 1). Additionally, a notification management component 830 can be employed to facilitate generation and delivery of alerts as described above, for example quota full alerts. It is to be appreciated that these components can enable functionality of like components (and sub-components) described supra.

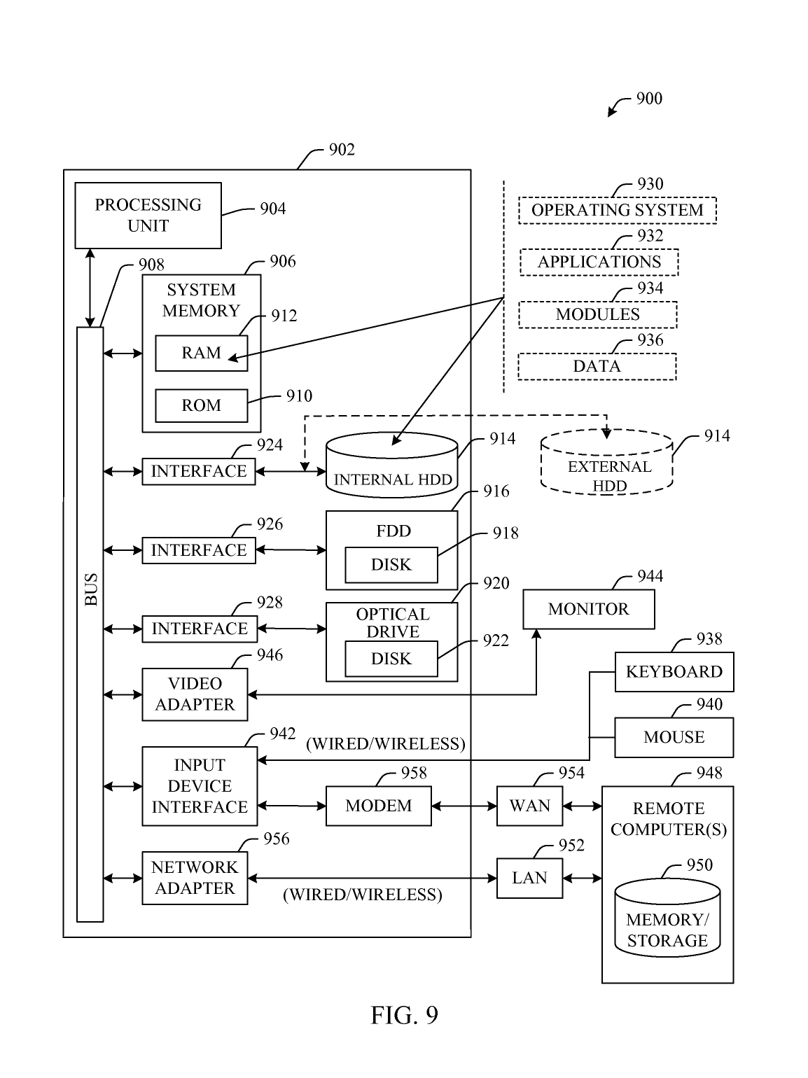

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

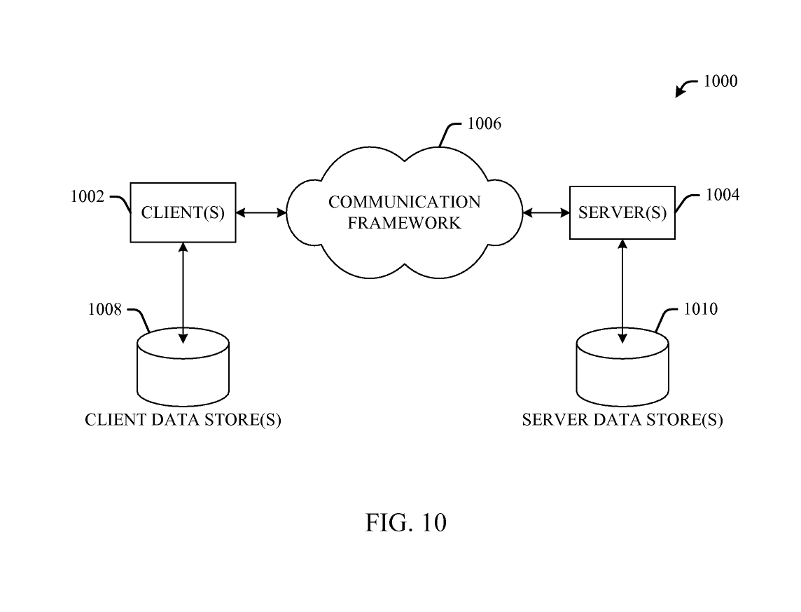

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates server quota notification, comprising:
a stats store component that maintains a quota parameter related to a mail server; and
a notification management component that generates an alert as a function of a quota level related to a user, wherein the alert is generated and communicated to the user by way of a mobile device.

2. The system of claim 1, wherein the notification management component is collocated within the mobile device.

3. The system of claim 2, wherein the mobile device is at least one of a cellular telephone, smartphone, personal data assistant (PDA), personal music player, or camera.

4. The system of claim 1, further comprising an alert generation component that establishes the alert as a function of the quota level.

5. The system of claim 4, the alert is one of an email message, calendar entry, task entry, SMS (short message service) alert, instant message (IM), audible message, or visual message.

6. The system of claim 4, further comprising a detection component that detects status of the quota level, wherein the status is employed in establishment of the alert.

7. The system of claim 6, further comprising an analysis component that evaluates the status and provides the alert generation component feedback to establish the alert.

8. The system of claim 4, further comprising an alert selection component that chooses a type for the alert from at least one of an email, calendar entry, task entry, SMS message, IM, audible, or visual message.

9. The system of claim 1, further comprising a plug-in component that defines a manner in which the alert is communicated via the mobile device.

10. The system of claim 1, further comprising a rendering component that conveys the alert to the user.

11. The system of claim 10, further comprising a protocol selection component that selects a protocol by which to communicate the alert.

12. The system of claim 11, wherein the protocol is at least one of an email application, SMS application, or IM application.

13. The system of claim 12, further comprising a communication component that employs the protocol to convey the alert.

14. The system of claim 1, further comprising a machine learning and reasoning component that employs at least one of a probabilistic and a statistical-based analysis that infers an action that a user desires to be automatically performed.

15. A computer-implemented method of notifying of server quota status via a mobile device, comprising:
monitoring a quota parameter associated to a user;
analyzing the quota parameter;
selecting a communication protocol for alerting the user of when the quota level reaches a critical level; and
alerting the user of the critical level by way of the communication protocol.

16. The computer-implemented method of claim 15, further comprising generating an alert, wherein the alert communicates the critical level.

17. The computer-implemented method of claim 16, wherein the alert is at least one of a locally generated email message, text message, a calendar entry or a task entry.

18. A computer-executable system that facilitates notification related to a server quota, comprising:
means for receiving a parameter related to the server quota;
means for analyzing the server quota in relation to a threshold;
means for generating an alert via a mobile device if the server quota exceeds the threshold; and
means for communicating the alert to a user by way of a protocol, wherein the protocol is at least one of an email message, a calendar entry or a task entry.

19. The computer-executable system, further comprising means for selecting the protocol based upon a user preference.

20. The computer-executable system, further comprising means for actively monitoring the parameter related to the server quota.
